(19) United States
(12) Patent Application Publication
(10) Pub. No.: US 2024/0338392 A1
(43) Pub. Date: Oct. 10, 2024

(54) INFORMATION PROCESSING METHOD AND DEVICE, ELECTRONIC APPARATUS AND STORAGE MEDIUM

(71) Applicant: Beijing Zitiao Network Technology Co., Ltd., Beijing (CN)

(72) Inventors: Jinxiang WANG, Beijing (CN); Yuanhui LIANG, Beijing (CN)

(21) Appl. No.: 18/625,945

(22) Filed: Apr. 3, 2024

(30) Foreign Application Priority Data
Apr. 6, 2023 (CN) 202310363780.5

(51) Int. Cl. G06F 16/31; G06F 16/338

(52) U.S. Cl. CPC G06F 16/322; G06F 16/338

(57) ABSTRACT

An information processing method and device, an electronic apparatus and a storage medium are disclosed. The information processing method includes: displaying a directory tree corresponding to documents in a document repository, wherein nodes are displayed in the directory tree according to a hierarchical relationship of the documents, and each of the nodes corresponds to at least one document; in response to a first operation event on the nodes in the directory tree, selecting a target node; in response to a second operation event on the target node, performing a bulk operation corresponding to the second operation event on a target document corresponding to the target node; the target document comprises at least two documents, and the target node comprises at least two nodes corresponding to the at least two documents.

### CROSS-REFERENCE TO RELATED APPLICATION

The present application claims priority of Chinese Patent Application No. 202310363780.5, filed on Apr. 6, 2023, for all purposes, the entire disclosure of the aforementioned application is incorporated by reference as part of the disclosure of the present application.

### TECHNICAL FIELD

The present disclosure relates to the technical field of computer technology, and in particular to an information processing method and device, an electronic apparatus, and a storage medium.

### BACKGROUND

A document, such as an online document, is stored in a document repository. For documents in the document repository, a user may perform a bulk operation on them, and the user needs to select the documents in the document repository that require the bulk operation and then perform the bulk operation.

### SUMMARY

The present disclosure provides an information processing method and device, an electronic apparatus, and a storage medium.

The present disclosure adopts the following technical solution.

In some embodiments, the present disclosure provides an information processing method, including:
displaying a directory tree corresponding to documents in a document repository, nodes are displayed in the directory tree according to a hierarchical relationship of the documents, and each of the nodes corresponds to at least one document;
in response to a first operation event on the nodes in the directory tree, selecting a target node;
in response to a second operation event on the target node, performing a bulk operation corresponding to the second operation event on a target document corresponding to the target node;
the target document includes at least two documents, and the target node includes at least two nodes corresponding to the at least two documents.

In some embodiments, the present disclosure provides an information processing device, including:
a displaying unit, configured to display a directory tree corresponding to documents in a document repository, nodes are displayed in the directory tree according to a hierarchical relationship of the documents, and each of the nodes corresponds to at least one document;
a controlling unit, configured to select a target node in response to a first operation event on the nodes in the directory tree; and perform a bulk operation corresponding to a second operation event on a target document corresponding to the target node in response to the second operation event on the target node;
the target document includes at least two documents, and the target node includes at least two nodes corresponding to the at least two documents.

In some embodiments, the present disclosure provides an electronic apparatus, including:
at least one memory and at least one processor;
the at least one memory is configured to store program codes, and the at least one processor is configured to invoke the program codes stored in the at least one memory to perform the method mentioned above.

In some embodiments, the present disclosure provides a storage medium, the computer-readable storage medium is configured for storing program codes, when the program codes are executed by a processor, the program codes cause the processor to perform the method mentioned above.

The information processing method provided by the embodiments of the present disclosure, achieves the bulk operation of the target document which the target node corresponds to by manipulating the target node in the directory tree, thereby facilitating users to perform the bulk operation on documents, reducing operation steps, and improving efficiency.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic and components and elements are not necessarily drawn to scale.

FIG. 1 is a flowchart of an information processing method according to an embodiment of the present disclosure.

FIG. 2 to FIG. 5 are schematic diagrams of display interfaces according to embodiments of the present disclosure.

FIG. 6 to FIG. 8 are schematic diagrams of a communication client according to embodiments of the present disclosure.

FIG. 9 is a schematic diagram of a structure of an electronic apparatus according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that various steps described in the method embodiments of the present disclosure can be performed in parallel and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modification of “a” mentioned in the present disclosure is schematic rather than limiting, and those skilled in the art should understand that it should be understood as “one or more” unless the context clearly indicates otherwise.

Names of messages or information exchanged among multiple devices in the embodiment of the present disclosure are only used for illustrative purposes, and are not used to limit the scope of these messages or information.

Hereinafter, solutions provided by embodiments of the present disclosure will be described in detail with reference to the attached drawings.

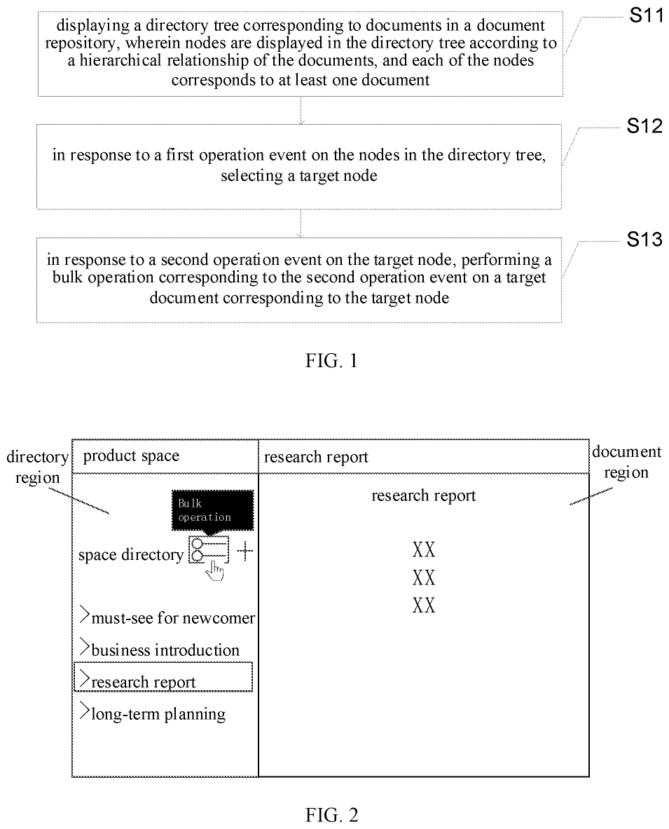

FIG. 1 is a flowchart of an information processing method according to an embodiment of the present disclosure, which can be configured for a terminal, a server, a browser and the like, and includes the following steps.
S11: displaying a directory tree corresponding to documents in a document repository, nodes are displayed in the directory tree according to a hierarchical relationship of the documents, and each of the nodes corresponds to at least one document.

In some embodiments, as illustrated in FIG. 2, a directory region (on the left of FIG. 2) and a document region (on the right of FIG. 2) are displayed in a displaying region of the document repository. The directory region (a region where “space directory” is located on the left in FIG. 2) displays the directory tree, and the document region is configured to display a currently viewed document. The directory tree adopts a hierarchical structure and includes nodes, which can include nodes corresponding to documents (“must-see for newcomer”, “business introduction”, “research report”, and “long-term planning” in FIG. 2 are nodes corresponding to documents). Documents can be online documents, and have a hierarchical relationship between them, and the hierarchical relationship between the documents can be determined by ownership relationship between the documents. For example, a chapter in document 1 can be another document 2, then document 2 is a child document of document 1, and a node corresponding to document 1 should be a parent node of a node corresponding to document 2, parent-child relationship between nodes can correspond to the ownership relationship between the documents, so that the directory tree can reflect relationship between documents in the document repository as a whole. The directory tree can be configured to record the hierarchical relationship of the documents in the document repository, and determine locations of nodes according to the ownership relationship between the documents, rather than determine the locations of the nodes according to relationship between up and low levels of folders where the documents are located. A document repository can correspondingly have a directory tree, and a node corresponding to a document in another document repository can be recorded in another directory tree, and another document repository may not adopt the directory tree to record the hierarchical relationship between documents, for example, may adopt a folder structure to record the relationship between documents, the folder structure can be a tree structure corresponding to relationship between the up and low levels of the folders where the documents are located.
S12: in response to a first operation event on the nodes in the directory tree, selecting a target node.

In some embodiments, the first operation event may include one or more operations, for example, the first operation event may include a selecting operation, such as selecting a target node by pulling or checking, where the target document includes at least two documents, and the target node includes at least two nodes corresponding to the at least two documents.
S13: in response to a second operation event on the target node, performing a bulk operation corresponding to the second operation event on a target document corresponding to the target node.

In some embodiments, the second operation event may include one or more operations. The second operation event can have different types, and the bulk operation on the target document are operated based on the type of the second operation event. In some embodiments of the present disclosure, the bulk operation corresponding to the second operation event can be performed on the target document that the target node corresponds to by executing the second operation event on the target node. In some embodiments, the second operation event may include an editing operation performed on the target node, in the case where a bulk editing operation is performed on the target node, the corresponding bulk editing operation of the same type can be performed on the target document based on the bulk editing operation performed on the target node, for example, in the case where the target node is moved to a lower level of another node, the target document will be moved below a document corresponding to the another node mentioned above. For example, in the case where the target node is deleted, the target document can be deleted accordingly.

In related technologies, for documents managed by the directory tree, a bulk operation on the documents cannot be performed directly in the directory tree. In some embodiments of the present disclosure, the second operation event is performed on the target node in the directory tree, and by executing the second operation event on the target node, the bulk operation corresponding to the target document can be performed. In some embodiments of the present disclosure, by manipulating the target node in the directory tree, the bulk operation of the target document which the target node corresponds to can be achieved, thereby facilitating users to perform the bulk operation on documents, reducing operation steps, and improving efficiency.

In some embodiments of the present disclosure, in response to a first operation event on the nodes in the directory tree, selecting a target node, includes: in response to a triggered operation on a first control, entering a preset state; and in the preset state, selecting the target node in response to a selecting operation of the nodes in the directory tree.

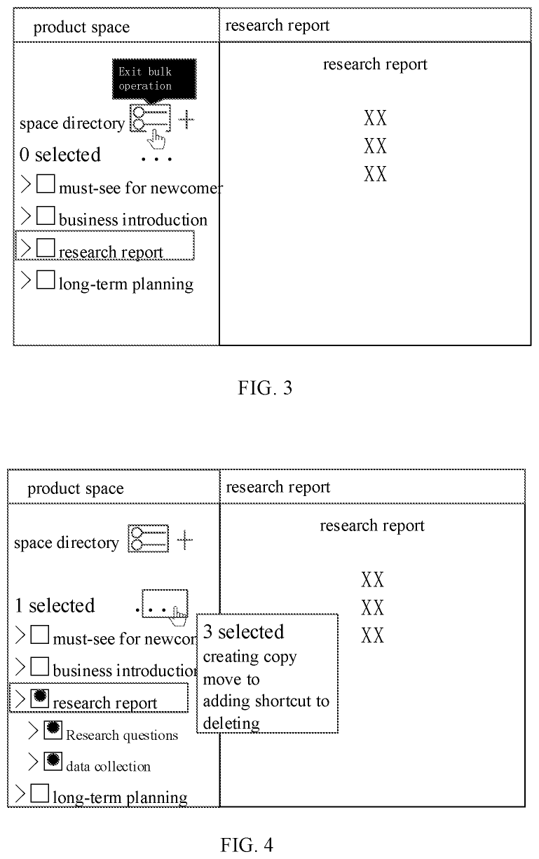

In some embodiments, as illustrated in FIG. 2, the control where a control identifier (the finger in FIG. 2) is located can be a first control, and the first control can be configured to enter and exit a preset state, the preset state can be a state for the bulk operation, and a purpose of the first control can be displayed when the control identifier hovers on the first control, in the case where the preset state is not entered, the purpose of the first control can be entering the bulk operation, in the case where the preset state is already entered, the purpose of the first control can be exiting the preset state, and the directory tree can be automatically folded and/or the directory tree can be refreshed when exiting the preset state. In some embodiments, during the period when the preset state is entered, a document displayed in the document region remains unchanged after a node is selected, and during the period when the preset state is not entered, after a node is selected, a corresponding document is displayed in the document region. In some embodiments, the preset state is set to distinguish between a selecting operation configured to view the document and a selecting operation configured to perform the bulk operation on the documents. In some embodiments, as illustrated in FIG. 3, after entering the preset state, a selecting box is displayed next to the node for selecting the node.

In some embodiments of the present disclosure, in response to a first operation event on the nodes in the directory tree, selecting a target node, includes: in response to a first preset operation performed based on a first node in the directory tree, entering the preset state and selecting the target node based on the first node.

In some embodiments, the first preset operation may be a pre-set shortcut operation, which may be, for example, triggering a preset button in the case where the first node is selected. For example, the preset button can be a “shift” button. In the case where the preset state has not been entered, the preset state can be automatically entered and the node can be selected in the case where the first preset operation is performed, after entering the preset state, the first preset operation can be performed based on the first node in the directory tree, and the node can be selected based on the first node. In some embodiments, in the case where the preset button is triggered when the first node is selected, all nodes between the first node and a node corresponding to a currently viewed document are selected. By setting the first preset operation, the processing efficiency of the user can be improved, so as to enter the preset state and select the node by one step.

In some embodiments of the present disclosure, the first control is displayed on top of the directory region where the directory tree is located. In some embodiments, by displaying the first control on the top of the directory region, no matter the directory tree is expanded or folded, the first control can always be viewed in the directory region, and the first control is always displayed in the display region, and the first control is not hidden because of expansion or browsing the directory tree, which ensures that the user can enter the preset state when browsing a deep level of the directory tree.

In some embodiments, selecting the node based on the first node, including: selecting all nodes between the first node and the node corresponding to the currently viewed document. In some embodiments, as illustrated in FIG. 2, during a period when the preset state is not entered, the node corresponding to the currently viewed document is “research report”, in the case where the first node is “must-see for newcomer”, all nodes between “research report” and “must-see for newcomer” will be selected.

In some embodiments, after entering the preset state, the preset state will be exited in the case where a page is refreshed. In some embodiments, after entering the preset state, the preset state can be exited by refreshing the page, and the node selected before exiting the preset state will be deselected.

In some embodiments, in the case where a parent node is selected, all child nodes under the parent node are automatically selected, in this case, the selecting of any child node cannot be canceled. In some embodiments, after the parent node is selected, in the case where the parent node is deselected, all child nodes under the parent node are automatically deselected.

In some embodiments, the number of a manually selected node is displayed at a preset location. In some embodiments, the manually selected node refers to a node whose selecting box is manually checked by the user, which is different from an automatically selected node, the automatically selected node, for example, can be the automatically selected child node by selecting the parent node. In the case where a parent node is selected, the number of the manually selected node is increased by one without counting the number of automatically selected child node, as illustrated in FIG. 4, “space directory” displays “1 selected”, which indicates that one manually selected node exists.

In some embodiments, in the case where the number of a selected node reaches a preset node number, another node in the directory tree cannot be selected. In some embodiments, the preset node number can be 50, which can be set, in the case where the preset node number is reached, no more nodes can be selected to avoid problems such as long waiting time and delaying caused by excessive processing at one time. In the case where the preset node number is reached, a message can be displayed when the control identifier hovers over the selecting box to indicate that the preset node number has been reached.

In some embodiments, in the case where the selected node includes a shortcut node and the shortcut node includes a child node, the child node under the shortcut node cannot be selected. In some embodiments, the shortcut node can be a shortcut of the node, which points to a source node, and a child node under the node shortcut is a child node under the source node, because of particularity of the shortcut node, in the case where the child node under the shortcut node can be selected through the shortcut node, a permission rule will be easily damaged, therefore, the child node under the shortcut node cannot be selected through the shortcut node, but the child node under the corresponding source node can be selected through the source node. For example, in the case where the shortcut node is selected, the child node under the shortcut node can be displayed and gray, when the control identifier hovers over the child node, prompt information can be displayed indicating that the child node cannot be selected. In some embodiments of the present disclosure, the child node includes a direct child node and an indirect child node of the parent node.

In some embodiments of the present disclosure, in response to the second operation event on the target node, performing a bulk operation corresponding to the second operation event on the target document corresponding to the target node, includes: in response to the second operation event on the target node, performing the bulk operation on a document in the target document that the target node corresponds to for which a current user has first preset permission.

In some embodiments, in the case of the bulk operation is perform on the target document, permission of the current user will be verified, for example, the first preset permission is permission required for the bulk operation, only documents on which the current user has the first preset permission will be performed the bulk operation, and the documents on which the current user does not have the first preset permission will not be performed the bulk operation, so that permission management can be achieved.

In some embodiments, for the second operation event, an operation it contains can be automatically recorded to a recent operation list. A latest operation can be viewed in the recent operation list to facilitate rollback.

In some embodiments of the present disclosure, in response to the second operation event on the target node, performing the bulk operation corresponding to the second operation event on the target document corresponding to the target node, including: displaying a list of an operation option in response to a triggering operation on a second control; in response to a selecting operation on a target operation option, performing a bulk operation corresponding to the target operation option on the target document.

In some embodiments, as illustrated in FIG. 3, a control where a hand-shaped control identifier is located is the second control, which can be displayed on the top of the directory region. After the second control is triggered by clicking or the like, an operation option is displayed, as illustrated in FIG. 4, the operation option can be configured to operate the node, so as to operate the document corresponding to the node. In the case where no node is selected, the second control cannot be triggered, for example, it can be set gray. By triggering the control identifier (for example, right-click) on the selected node, a list of the bulk operation can be displayed, and by triggering the control identifier on an unselected node, only a list of processing operation for a single document can be displayed. As illustrated in FIG. 4, a total number of selected nodes, as well as the automatically selected node, for example “3 selected”, can be displayed in an association region of the operation option. In some embodiments, the operation option is not selectable in the case where the node is not selected, thereby avoiding an invalid operation.

In some embodiments of the present disclosure, in response to a second operation event on the target node, performing the bulk operation corresponding to the second operation event on a target document corresponding to the target node, includes: in response to the target node being dragged to a second node in the directory tree, moving the target document to a location corresponding to the second node. In some embodiments, a plurality of documents can be moved by dragging a plurality of nodes.

In some embodiments, as illustrated in FIG. 4, the operation options include: a moving option, which is configured to identify a third node and move the target node to the third node, thereby moving the target document to a location corresponding to the third node; a creating shortcut option, which is configured to identify a fourth node and create a shortcut node for the target node at the fourth node; a creating copy option, which is configured to identify a fifth node and creating a node corresponding to a copy of the target document at the fifth node, thereby creating the copy of the target document at a location corresponding to the fifth node; a transferring ownership option, which is configured to transfer ownership of the target document to a specified user; a deleting option, which is configured to delete the target node, thereby deleting the target document. In some embodiments, the third node, the fourth node, and the fifth node are nodes that are required to be selected by the current user after the corresponding node has been selected.

In some embodiments, the location corresponding to the second node to which the target document is moved is different from a location of the target document and a location of a subordinate of the target document before the target document being moved. In some embodiments, in the case where the target document is moved by dragging the node, it is needed to ensure that the location corresponding to the second node which is moved to is not an original location of any document in the target document, or an original location of the document corresponding to the child node of the target node, so as to avoid circular nesting and cause confusion.

In some embodiments, in the case where the target node and the target document are moved, cascade movement is adopted by default, that is, moving the parent node will make the child node under the parent node be automatically moved.

In some embodiments, the target operation option is the moving option, and in the case where a document that a current user does not have moving permission is in the target document, the moving option will not be allowed to be selected. In the case where a document that does not meet the moving permission is in the target document, the moving option can be set gray, which indicates that no moving permission is for all documents when the control identifier hovers over the moving option, so that an invalid operation can be avoided.

In some embodiments, in the case where the current user does not have second preset permission for the location corresponding to the third node, the target document is not allowed to be moved to the location corresponding to the third node. In some embodiments, the second preset permission is, for example, writing permission, because the target node needs to be moved to the position corresponding to the third node, it is needed to determine the permission of the current user to avoid a failure to move the target document to the position corresponding to the third node. In some embodiments, the corresponding positions of each node may be predetermined. The second node, the third node, the fourth node, and/or the fifth node can be child nodes that already exist in the directory tree, in the case of determining the second node, the third node, the fourth node, and/or the fifth node, by selecting the corresponding parent node, a new child node can be automatically created under the parent node as the second node, the third node, the fourth node, and/or the fifth node.

In some embodiments, a node of another document repository that does not adopt a directory tree cannot be identified as the third node. In some embodiments, another document repository that does not adopt the directory tree may adopt a folder structure, which does not adopt the directory tree to identify the hierarchical relationship between documents, but may adopt a tree structure that hierarchical relationship of storage location corresponds to, in the case where nodes from another document repository are introduced into the directory tree, the hierarchical relationship that the directory tree originally had will be destroyed, therefore, the node of another document repository that does not adopt the directory tree cannot be set as the third node.

In some embodiments, the location corresponding to the third node to which the target document is moved is different from a location of the target document and a location of a subordinate of the target document before the target document is moved. In some embodiments, the subordinate of the target document may refer to a document corresponding to the child node (direct child node, or indirect child node) of the target node, and in the case where the location of the target document or the location of the subordinate of the target document is selected as the third node, a confirmation button may be set gray, and a prompt can be given indicating that selecting the original location or its subpage is not supported, which avoids confusion caused by loop nesting.

In some embodiments, in a process of moving the target document, another document in the document repository is in an immovable state. The target document can be moved asynchronously. During this process, the directory tree is locked, and another moving operation cannot be performed, in the case where another document is in a moveable state, an original location of the third node may disappear, which results in the failure to move.

In some embodiments, in the case where a document that the current user does not have the third preset permission is in the target document, the document that the current user does not have the third preset permission is not allowed to be moved, so as to avoid unauthorized action, and only the document within the third preset permission can be moved.

In some embodiments, before moving the target document, a pop-up window will be displayed for the user to confirm, the target document will be moved after confirmation, and a moving-in-progress symbol can be displayed during the moving process.

In some embodiments of the present disclosure, the target operation option is the deleting option, in the case where a document that the current user does not have deleting permission is in the target document, the deleting option is not allowed to be selected. In some embodiments, during a process of deleting a node, cascading deleting is performed by default, and deleting the parent node will make the child node be deleted. Before deleting, authentication is required to ensure that the current user has the right to delete the document to avoid unauthorized deleting. In the case where the deleting option is unselectable, a reason why the deleting option is unselectable can be prompted when the control identifier hovers over the deleting option.

In some embodiments, in a process of deleting the target document, the target document is in an operational state. In some embodiments, asynchronous deleting is adopted, and the document before deleting can be manipulated, for example, viewed. In some embodiments, in the process of deleting the target document, the target document will be still deleted in the case where the target document is moved to another location in the document repository.

In some embodiments, in the process of deleting the target document, in the case where the target document is moved to another document repository, the target document moved to the another document repository will fail to be deleted. In some embodiments, when the target document is moved to another document repository, the target document has already belonged to another document repository, in the case of deleting it through the directory tree of the document repository, authority may be exceeded, and therefore, the target document cannot be deleted in this case.

In some embodiments, in the case where a node that the current user does not have fourth preset permission is in the target node, the node that the current user does not have the fourth preset permission is not allowed to be deleted. In some embodiments, the target document is deleted by deleting the target node, so it is needed to require the current user to have permission, that is, the fourth preset permission, to delete the target node. In the case where a node that the current user does not have the fourth preset permission exists, the node cannot be deleted and the next node is deleted instead.

In some embodiments, after the deleting option has been selected, a pop-up window can be displayed for a secondary confirmation, after the deleting has been confirmed, the target document can be deleted, and a deleting-in-progress symbol can be displayed during the deleting process.

In some embodiments of the present disclosure, the target operation option is the creating shortcut option. In the case where the current user does not have fifth preset permission for the fourth node, the current user cannot create the shortcut node of the target node at the fourth node. In some embodiments, the fourth node is a node selected to display the created shortcut, and the fourth node can be a child node of a certain node, and a new child node can be created under the parent node as the fourth node by selecting the parent node. Because the shortcut node is to be created at the location of the fourth node, it needs to have certain permission, such as editing permission, so as to avoid exceeding authority.

In some embodiments, a node of another document repository that does not adopt the directory tree cannot be identified as the fourth node. In some embodiments, nodes of another document repository that does not adopt the directory tree to manage documents cannot be selected through search or recent access, so as to avoid management confusion, and the directory tree being not adopting means that nodes, the documents correspond to, are displayed without adopting the directory tree according to the hierarchical relationship of the documents.

In some embodiments, the fourth node where the shortcut node is created is different from the target node and a child node of the target node. In the case where the target node or a child node of the target node is selected as the fourth node, a confirmation button for confirming the selection can be disabled, thereby avoiding performing an operation of creating a shortcut node, and when the control identifier hovers over the confirmation button, a reason for disabling can be prompted, such as “adding shortcuts to the original page is not supported”.

In some embodiments, in a process of creating the shortcut node of the target document, the target document is in an operational state. In some embodiments, a manner of asynchronous creating can be adopted and the directory tree is not locked, another user can operate the document which the created shortcut node corresponds to.

In some embodiments, in the case where the target document is deleted in the process of creating the shortcut node of the target document, creating the shortcut node of the deleted target document will fail. At this time, the target document has been deleted, and the document to which the shortcut node points does not exist, therefore creating the shortcut node of the deleted target document fails.

In some embodiments, in the case where the target node includes an existing shortcut node, the existing shortcut node in the target node can be copied to the fourth node. In some embodiments, in the case where a shortcut node exists in the target node, the shortcut node does not need to be created repeatedly, and the existing shortcut node can be directly copied to the fourth node, and in this case, the child node under the existing shortcut node do no need to be processed, and the situation that the shortcut points to the shortcut can be avoided.

In some embodiments, in the case where the target node includes the existing shortcut node, the current user does not need to have permission to view a document to which the existing shortcut node corresponds. In some embodiments, the shortcut node is merely a shortcut, and is checked for viewing permission when accessing the document, so it is not necessary to verify viewing permission for the document when copying the shortcut node.

In some embodiments, an option to create a shortcut can be viewed as long as the preset state can be entered, and a creating-in-progress symbol can be displayed during the creating process of a shortcut node.

In some embodiments of the present disclosure, the target operation option is the creating copy option, in the case where a document that a current user does not have permission to create a copy is in the target document, the creating copy option is not allowed to be selected. This can prevent an unauthorized action and an invalid operation, a reason why this option cannot be selected can be prompted when the control identifier hovers over the creating copy option.

In some embodiments, in the case where the current user does not have sixth preset permission to the location corresponding to the fifth node, the copy of the target document at the location corresponding to the fifth node is not allowed to be created. In some embodiments, the corresponding location may refer to an actual location in the document repository, because the copy of the target document is to be created at the corresponding location of the fifth node, it is needed to have permission, for example, writing permission, of the location to avoid an unauthorized action.

In some embodiments, a node of another document repository that does not adopt the directory tree is not allowed to be identified as the fifth node, and another document repository may adopt the folder structure to manage the documents, in the case where the copy of the document is created to another document repository, this may conflict with the management of the directory tree structure, resulting in confusion of management results.

In some embodiments, a location corresponding to the fifth node where a created document copy is located is not belonged to a subordinate of the target document. In some embodiments, a subordinate of the target document may be a document that is directly or indirectly affiliated to the target document in the hierarchical relationship. The subordinate of the target document can be determined as follows: determining the node corresponding to the target document, and determining the document corresponding to the child node of the node, which is the subordinate of the target document. In the case where the node corresponding to the subordinate of the target document is selected as the fifth node, the confirmation button can be set gray, and creating a copy under the original document being not supported can be prompted, which can avoid situations where the subordinate of the target document is the copy of itself, which may lead to confusion and possibly even a loop.

In some embodiments, before creating the copy of the target document, estimated time is calculated, in the case where the estimated time is less than preset time, the copy of the target document can be created, and in the case where the estimated time is not less than the preset time, reminder information can be displayed, and after the reminder information is confirmed, the copy of the target document can be created.

In some embodiments, the system may estimate time before creating the copy of the target document, in the case where the time is too long, the user will be allowed to confirm the time twice to prevent the user from waiting. The number of copies created at one time can be set to an upper limit, such as 100, and in the case where the number of target documents exceeds the upper limit, a reminder information can be displayed. The preset time can be set in advance and can be bound to the user, and different users can set their own preset time, for example, 10 seconds. In the case where the estimated time is less than preset time, the copy of the target document can be created directly, during the creating process, an in-progress symbol can be displayed; in the case where the estimated time exceeds the preset time, a confirmation page can be displayed, which can display reminder information, for example, the reminder information includes the estimated time, after the reminder information is confirmed, the copy starts to be created, in the case where the reminder information is not confirmed or canceled, the copy is paused to create, so that the user can select the target node again to reduce the number of copies that needs to be created.

In some embodiments of the present disclosure, in the case where the bulk operation corresponding to the second operation event on the target document is successful, a first prompt message can be sent; in the case where the bulk operation of a part of documents of the target document is successful, a second prompt message can be sent, and a result notification message to a current user and/or an owner of the target document can be sent through a preset communication client; in the case where the bulk operation on the target document fails, a third prompt message can be sent.

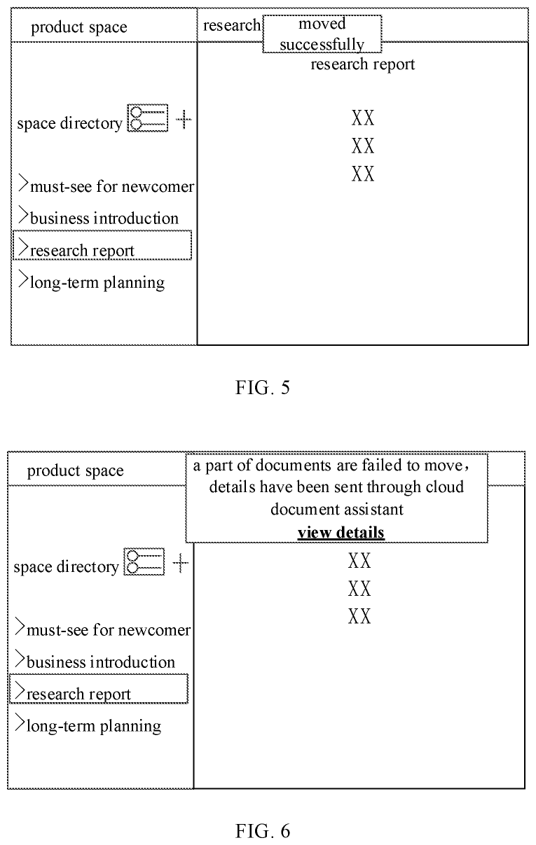

In some embodiments, the first prompt message is illustrated graphically in FIG. 5, and the second prompt message is illustrated graphically in FIG. 6. After operations such as moving, deleting, creating a copy, or creating a shortcut node for the target document, a corresponding prompt message based on the bulk operation result can be sent, which indicates that the operation has succeeded, failed, or partially succeeded. In the case where the operation has partially succeeded, details are prompted to be viewed in a specified session in the communication client, where a result notification message is sent to the current user and the owner of the target document, and an entry to the specified session in the communication client can be provided (for example, “view details” in FIG. 6 can be triggered to enter the “cloud document assistant” session). In some embodiments, a difference exists between the result notification message received by the current user and the result notification message received by the owner of the target document, the difference may be that the result notification message received by the current user may include bulk operation results of all the target documents, while in the result notification message received by the owner of the target document, only a bulk operation result of the target document that the owner has can be included, and a bulk operation result of the document that the current user does not have will not be recorded, thereby avoiding information leakage.

In some embodiments of the present disclosure, in the case where a number of documents of failed bulk operations is not greater than a preset document number, the documents of failed bulk operations are displayed in the result notification message; and/or in the case where the number of documents of failed bulk operations is greater than the preset document number, the preset document number of the documents of failed bulk operations and detail controls are displayed in the result notification message, each of the detail controls is configured to export detail message about a result of the bulk operations.

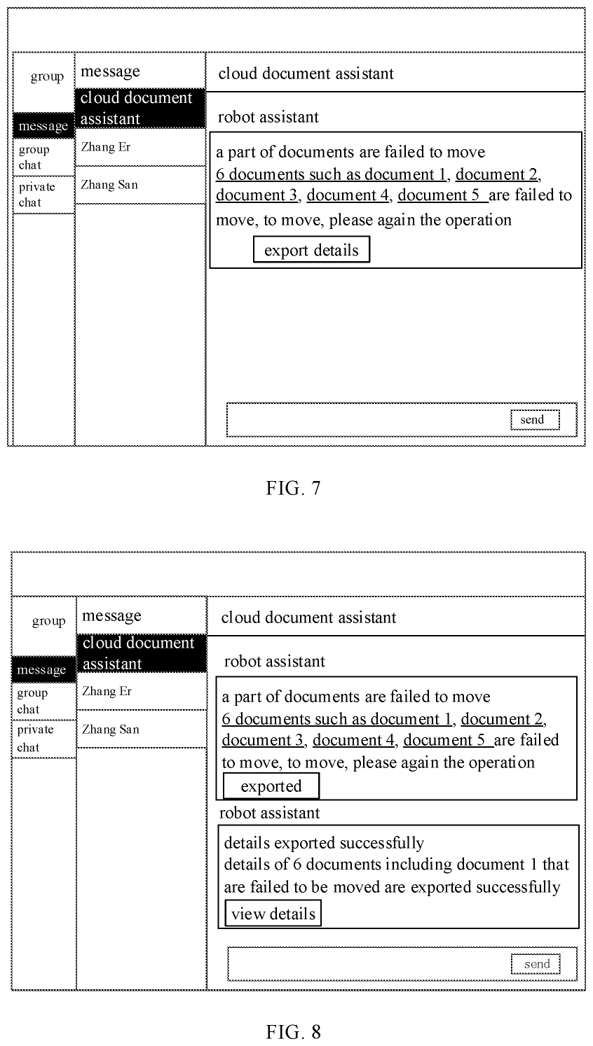

In some embodiments, as illustrated in FIG. 7, the communication client is a communication client bound to an account of the current user, and a robot in the communication client can send the result notification message, the result notification message includes a message title “a part of documents are failed to move”, message content “6 documents such as document 1, document 2, document 3, document 4 and document 5 are failed to move, to move, please again the operation”, and a detail control “export details” that can be triggered, the message title and the message content can be different according to the second operation event, for example, for failing to delete a part of the documents, “failed to move” can be replaced with “failed to delete” in the message title and message content in FIG. 7. For the message content, document names are displayed by default at most for the preset number of documents, and other document names are not displayed, but a total number of the failed documents in the bulk operation can be displayed, and these document names can be triggered to open the documents.

In some embodiments, the result notification message received by the current user displays all documents of failed bulk operation with a maximum preset document number, while the result notification message received by the owner of the target document may display only the documents possessed by the owner with a maximum preset document number, without recording the documents not possessed by the current user, only the documents displayed are different, otherwise the same.

Some embodiments further includes that in response to a triggering of the detail control, a result document can be created, and information of the target document and the bulk operation result can be displayed in the result document. In some embodiments, the detail control can be triggered by clicking and the like, after the detail control is triggered, displayed content can be changed, for example, as illustrated in FIG. 8, after the detail control is triggered, the displayed content changes from “export details” to “exported”. The result document created is configured to display the details of the exported bulk operation result, an export result notification message can be sent in the same session as the result notification message in the communication client, and a control can be provided to view the result document (“view details” in FIG. 8), and the export result notification message includes a title “details exported successfully” and content “details of 6 documents including document 1 that are failed to be moved are exported successfully”. In the case where the details of the bulk operation result fail to be exported, content of the result notification message is changed correspondingly to the details being failed to export, and a control for re-exporting the bulk operation result can be provided. For the result document, it can be created in a personal space of the current user, and the owner is the current user, and it can record a title, a number, an operation date, a link corresponding to the document, and a bulk operation result of the target document.

In some embodiments of the present disclosure, an information processing device is further provided, which includes:
a displaying unit, which is configured to display a directory tree corresponding to documents in a document repository, nodes are displayed in the directory tree according to the hierarchical relationship of the document, and each of the nodes corresponds to at least one document;
a controlling unit, which is configured to select a target node in response to a first operation event on the nodes in the directory tree; and perform a bulk operation corresponding to the second operation event on a target document corresponding to the target node in response to a second operation event on the target node;
the target document includes at least two documents, and the target node includes at least two nodes corresponding to the at least two documents.

For the device embodiment, because it basically corresponds to the method embodiment, reference may be made to the partial description of the method embodiment for relevant points. The device embodiments described above are only schematic, in which the modules described as separate modules may or may not be separate. Some or all of the modules may be selected according to actual needs to achieve the objective of the implementation. One of ordinary skill in the art can understand and implement without inventive effort.

The method and device of the present disclosure have been described above based on the embodiments and application examples. In addition, the present disclosure further provides an electronic apparatus and a computer-readable storage medium, which are described below.

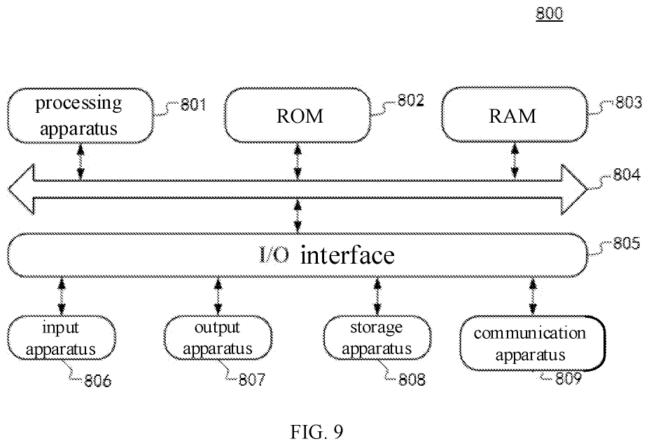

Reference is now made to FIG. 9, which illustrates a schematic diagram of a structure of an electronic apparatus (for example, a terminal device or a server) 800 suitable for implementing some embodiments of the present disclosure. The terminal devices in some embodiments of the present disclosure may include, but are not limited to, mobile terminals such as a mobile phone, a notebook computer, a digital broadcasting receiver, a personal digital assistant (PDA), a tablet computer (PAD), a portable media player (PMP), a vehicle-mounted terminal (for example, a vehicle-mounted navigation terminal) and the like, and fixed terminals such as a digital TV, a desktop computer and the like. The electronic apparatus illustrated in the figure is only an example, and should not pose any limitation to the functions and the scope of use of the embodiments of the present disclosure.

The electronic apparatus 800 may include a processing device (for example, a central processing unit, a graphics processing unit and the like) 801, which may perform various suitable actions and processes according to a program stored in a read-only memory (ROM) 802 or a program loaded from a storage device 808 into a random-access memory (RAM) 803. In the RAM 803, various programs and data required for operations of the electronic apparatus 800 are further stored. The processing device 801, the ROM 802 and the RAM 803 are interconnected by means of a bus 804. An input/output (I/O) interface 805 is also connected to the bus 804.

Generally, the following devices may be connected to the I/O interface 805: an input device 806 including, for example, a touch screen, a touch pad, a keyboard, a mouse, a camera, a microphone, an accelerometer, a gyroscope, etc.; an output device 807 including, for example, a liquid crystal display (LCD), a loudspeaker, a vibrator, etc.; a storage device 808 including, for example, a magnetic tape, a hard disk, etc.; and a communication device 809. The communication device 809 may allow the electronic apparatus 800 to perform wireless or wired communication with other devices to exchange data. While the electronic apparatus 800 with various devices is illustrated in the figure, it should be understood that it is not required to implement or have all the devices illustrated. More or fewer devices may alternatively be implemented or provided.

In particular, according to the embodiments of the present disclosure, the processes described above with reference to the flowcharts may be implemented as a computer software program. For example, an embodiment of the present disclosure includes a computer program product, which includes a computer program carried by a computer-readable medium, the computer program includes program codes for performing the method illustrated in the flowchart. In such an embodiment, the computer program may be downloaded and installed from a network through the communication device 809, or installed from the storage device 808, or installed from the ROM 802. When the computer program is executed by the processing device 801, the above-mentioned functions defined in the method of the embodiment of the present disclosure are performed.

It should be noted that the computer-readable medium mentioned above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device or device, or any combination thereof. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, device or device. In the present disclosure, the computer-readable signal medium may include a data signal propagated in a baseband or as a part of a carrier wave, in which computer-readable program codes are carried. This propagated data signal may take multiple forms, including but not limited to an electromagnetic signal, an optical signal or any suitable combination of the above. The computer-readable signal medium may also be any computer-readable medium other than the computer-readable storage medium, and may send, propagate or transmit a program used by or in combination with an instruction execution system, device or device. The program codes contained on the computer-readable medium may be transmitted by any suitable medium, including but not limited to: an electric wire, a fiber-optic cable, radio frequency (RF) and the like, or any suitable combination of the above.

In some implementation methods, a client and the server can communicate by using any currently known or future developed network protocol such as a hypertext transfer protocol (HTTP), and may communicate and interconnect with digital data in any form or medium (for example, a communication network). Examples of the communication network include a local area network (“LAN”), a wide area network (“WAN”), the Internet work (for example, the Internet) and an end-to-end network (for example, an ad hoc end-to-end network), as well as any currently known or to be researched and developed in the future.

The computer-readable medium described above may be included in the above-mentioned electronic apparatus; or it may exist alone without being assembled into the electronic apparatus.

The computer-readable medium described above carries one or more programs, which, when executed by the electronic apparatus, cause the electronic apparatus to perform the method of the present disclosure.

Computer program codes for performing the operations of the present disclosure may be written in one or more programming languages or a combination thereof, including object-oriented programming languages such as Java, Smalltalk and C++, and also include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. Among them, the name of the unit does not constitute a limitation on the unit itself in some cases.

The functions described above herein may be at least partially performed by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a tangible medium that may include or store a program used by or in connection with an instruction execution system, device or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, an information processing method is provided, and includes:
displaying a directory tree corresponding to documents in a document repository, wherein nodes are displayed in the directory tree according to a hierarchical relationship of the documents, and each of the nodes corresponds to at least one document;
in response to a first operation event on the nodes in the directory tree, selecting a target node;
in response to a second operation event on the target node, performing a bulk operation corresponding to the second operation event on a target document corresponding to the target node;
wherein the target document comprises at least two documents, and the target node comprises at least two nodes corresponding to the at least two documents.

According to one or more embodiments of the present disclosure, an information processing method is provided, in response to a first operation event on the nodes in the directory tree, selecting a target node, comprises:
in response to a triggered operation on a first control, entering a preset state; and in the preset state, selecting the target node in response to a selecting operation of the nodes in the directory tree; or,
in response to a first preset operation performed based on a first node in the directory tree, entering the preset state and selecting the target node based on the first node.

According to one or more embodiments of the present disclosure, an information processing method is provided, and satisfies at least one of the following:
the first control being displayed on top of a directory region where the directory tree is located;
the first preset operation performed based on the first node in the directory tree, comprising: triggering a preset button in a case where the first node is selected;
selecting the target node based on the first node, comprising: selecting all nodes between the first node and a node corresponding to a document currently viewed;
after entering the preset state, in a case where a page is refreshed, exiting the preset state;
after entering the preset state, in a case where the first preset operation is performed based on the first node in the directory tree, selecting the target node based on the first node.

According to one or more embodiments of the present disclosure, an information processing method is provided, displaying a directory tree corresponding to documents in a document repository, comprises:
displaying a directory region and a document region in a displaying region of the document repository, wherein the directory region is configured to display the directory tree, and the document region is configured to display a document currently viewed.

According to one or more embodiments of the present disclosure, an information processing method is provided, and further includes at least one of the following:
in a case where a parent node is selected, all child nodes under the parent node being automatically selected; or,
in a case where the parent node is deselected, the all child nodes under the parent node are automatically deselected; or, displaying a number of a manually selected node at a preset location; or,
in a case where a number of a selected node reaches a preset node number, another node in the directory tree being not allowed to be selected; or,
in a case where a selected node comprises a shortcut node and the shortcut node includes a child node, the child node under the shortcut node being not allowed to be selected; or,
in a case where a preset button is triggered in a case where a first node is selected, all nodes between the first node and a node corresponding to a document currently viewed being selected.

According to one or more embodiments of the present disclosure, an information processing method is provided, in response to a second operation event on the target node, performing a bulk operation corresponding to the second operation event on a target document corresponding to the target node, comprises:
in response to the second operation event on the target node, performing the bulk operation on a document in the target document that the target node corresponds to for which a current user has a first preset permission.

According to one or more embodiments of the present disclosure, an information processing method is provided, in response to a second operation event on the target node, performing a bulk operation corresponding to the second operation event on a target document corresponding to the target node, comprises:
displaying a list of an operation option in response to a triggering operation on a second control; in response to a selecting operation on a target operation option, performing a bulk operation corresponding to the target operation option on the target document;
or,
in response to the target node being dragged to a second node in the directory tree,
moving the target document to a location corresponding to the second node.

According to one or more embodiments of the present disclosure, an information processing method is provided, the operation option comprises:
a moving option, configured to identify a third node and move the target node to the third node, thereby moving the target document to a location corresponding to the third node;
a creating shortcut option, configured to identify a fourth node and create a shortcut node for the target node at the fourth node;
a creating copy option, configured to identify a fifth node and creating a node corresponding to a copy of the target document at the fifth node, thereby creating the copy of the target document at a location corresponding to the fifth node;
a transferring ownership option, configured to transfer ownership of the target document to a specified user;
a deleting option, configured to delete the target node, thereby deleting the target document.

According to one or more embodiments of the present disclosure, an information processing method is provided, and satisfies at least one of the following:
in a case where no node is selected, the operation option being not allowed to be selected;
the location corresponding to the second node to which the target document is moved being different from a location of the target document and a location of a subordinate of the target document before the target document being moved.

According to one or more embodiments of the present disclosure, an information processing method is provided, the target operation option is the moving option and the method satisfies at least one of the following:
in a case where a document that a current user does not have moving permission is in the target document, the moving option being not allowed to be selected;
in a case where the current user does not have second preset permission for the location corresponding to the third node, the target document being not allowed to be moved to the location corresponding to the third node;
a node of another document repository that does not adopt the directory tree being not allowed to be identified as the third node;
the location corresponding to the third node to which the target document is moved being different from a location of the target document and a location of a subordinate of the target document before the target document being moved;
in a process of moving the target document, another document in the document repository being in an immovable state;
in a case where a document that the current user does not have third preset permission is in the target document, the document that the current user does not have the third preset permission being not allowed to be moved.

According to one or more embodiments of the present disclosure, an information processing method is provided, the target operation option is the deleting option and the method satisfies at least one of the following:
in a case where a document that a current user does not have deleting permission is in the target document, the deleting option being not allowed to be selected;
in a process of deleting the target document, the target document being in an operational state;
in the process of deleting the target document, in a case where the target document is moved to another location in the document repository, the target document being still deleted;
in the process of deleting the target document, in a case where the target document is moved to another document repository, deleting the target document moved to the another document repository failing;
in a case where a node that the current user does not have fourth preset permission is in the target node, the node that the current user does not have the fourth preset permission being not allowed to be deleted.

According to one or more embodiments of the present disclosure, an information processing method is provided, the target operation option is the creating shortcut option and the method satisfies at least one of the following:
in a case where a current user does not have fifth preset permission for the fourth node, the current user being not allowed to create the shortcut node of the target node at the fourth node;
a node of another document repository that does not adopt the directory tree being not allowed to be identified as the fourth node;
the fourth node where the shortcut node is created being different from the target node and a child node of the target node;
in a process of creating the shortcut node of the target document, the target document being in an operational state;
in a case where the target document is deleted in the process of creating the shortcut node of the target document, creating the shortcut node of the deleted target document failing;
in a case where the target node comprises an existing shortcut node, copying the existing shortcut node in the target node to the fourth node;
in the case where the target node comprises the existing shortcut node, the current user does not need to have permission to view a document to which the existing shortcut node corresponds.

According to one or more embodiments of the present disclosure, an information processing method is provided, the target operation option is the creating copy option and the method satisfies at least one of the following:
in a case where a document that a current user does not have permission to create a copy is in the target document, the creating copy option being not allowed to be selected;
in a case where the current user does not have sixth preset permission to the location corresponding to the fifth node, the copy of the target document at the location corresponding to the fifth node being not allowed to be created;
a node of another document repository that does not adopt the directory tree being not allowed to be identified as the fifth node;
a location corresponding to the fifth node where a created document copy is located being not belonged to a subordinate of the target document;
before creating the copy of the target document, calculating estimated time, in a case where the estimated time is less than preset time, the copy of the target document being allowed to be created, in a case where the estimated time is not less than the preset time, displaying reminder information, and after the reminder information is confirmed, creating the copy of the target document.

According to one or more embodiments of the present disclosure, an information processing method is provided and further includes at least one of the following:
in a case where the bulk operation corresponding to the second operation event on the target document is successful, sending a first prompt message;
in a case where the bulk operation on a part of documents of the target document is successful, sending a second prompt message, and sending a result notification message to a current user and/or an owner of the target document through a preset communication client;
in a case where the bulk operation on the target document fails, sending a third prompt message.

According to one or more embodiments of the present disclosure, an information processing method is provided, in a case where a number of documents of failed bulk operation is not greater than a preset document number, the documents of failed bulk operation are displayed in the result notification message; and/or
in a case where the number of documents of failed bulk operation is greater than the preset document number, the preset document number of the documents of failed bulk operation and detail controls are displayed in the result notification message, each of the detail controls is configured to export detail message about a result of the bulk operation.

According to one or more embodiments of the present disclosure, an information processing method is provided, and further includes:
in response to a triggering of each of the detail controls, creating a result document, and displaying information of the target document and a result of the bulk operation.

According to one or more embodiments of the present disclosure, an information processing device is provided, and includes:
a displaying unit, configured to display a directory tree corresponding to documents in a document repository, wherein nodes are displayed in the directory tree according to a hierarchical relationship of the documents, and each of the nodes corresponds to at least one document;
a controlling unit, configured to select a target node in response to a first operation event on the nodes in the directory tree; and perform a bulk operation corresponding to the second operation event on a target document corresponding to the target node in response to a second operation event on the target node;
wherein the target document comprises at least two documents, and the target node comprises at least two nodes corresponding to the at least two documents.

According to one or more embodiments of the present disclosure, an electronic apparatus is provided, and includes:
at least one memory and at least one processor;
wherein the at least one memory is configured to store program codes, and the at least one processor is configured to invoke the program codes stored in the at least one memory to perform any one of the above methods.

According to one or more embodiments of the present disclosure, a computer-readable storage medium is provided, the computer-readable storage medium being configured for storing program codes which, when executed by a processor, cause the processor to perform any one of the above methods.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. An information processing method, comprising:
displaying a directory tree corresponding to documents in a document repository, wherein nodes are displayed in the directory tree according to a hierarchical relationship of the documents, and each of the nodes corresponds to at least one document;
in response to a first operation event on the nodes in the directory tree, selecting a target node;
in response to a second operation event on the target node, performing a bulk operation corresponding to the second operation event on a target document corresponding to the target node;
wherein the target document comprises at least two documents, and the target node comprises at least two nodes corresponding to the at least two documents.

2. The method according to claim 1, wherein in response to a first operation event on the nodes in the directory tree, selecting a target node, comprises:
in response to a triggered operation on a first control, entering a preset state; and in the preset state, selecting the target node in response to a selecting operation of the nodes in the directory tree; or,
in response to a first preset operation performed based on a first node in the directory tree, entering the preset state and selecting the target node based on the first node.

3. The method according to claim 2, satisfying at least one of the following:
the first control being displayed on top of a directory region where the directory tree is located;
the first preset operation performed based on the first node in the directory tree, comprising: triggering a preset button in a case where the first node is selected;
selecting the target node based on the first node, comprising: selecting all nodes between the first node and a node corresponding to a document currently viewed;
after entering the preset state, in a case where a page is refreshed, exiting the preset state;
after entering the preset state, in a case where the first preset operation is performed based on the first node in the directory tree, selecting the target node based on the first node.

4. The method according to claim 1, wherein displaying a directory tree corresponding to documents in a document repository, comprises:
displaying a directory region and a document region in a displaying region of the document repository, wherein the directory region is configured to display the directory tree, and the document region is configured to display a document currently viewed.

5. The method according to claim 1, further comprising at least one of the following:
in a case where a parent node is selected, all child nodes under the parent node being automatically selected; or,
in a case where the parent node is deselected, the all child nodes under the parent node are automatically deselected; or,
displaying a number of a manually selected node at a preset location; or,
in a case where a number of a selected node reaches a preset node number, another node in the directory tree being not allowed to be selected; or,
in a case where a selected node comprises a shortcut node and the shortcut node includes a child node, the child node under the shortcut node being not allowed to be selected; or,
in a case where a preset button is triggered in a case where a first node is selected, all nodes between the first node and a node corresponding to a document currently viewed being selected.

6. The method according to claim 1, wherein in response to a second operation event on the target node, performing a bulk operation corresponding to the second operation event on a target document corresponding to the target node, comprises:
in response to the second operation event on the target node, performing the bulk operation on a document in the target document that the target node corresponds to for which a current user has a first preset permission.

7. The method according to claim 1, wherein in response to a second operation event on the target node, performing a bulk operation corresponding to the second operation event on a target document corresponding to the target node, comprises:
displaying a list of an operation option in response to a triggering operation on a second control; in response to a selecting operation on a target operation option, performing a bulk operation corresponding to the target operation option on the target document;
or,
in response to the target node being dragged to a second node in the directory tree, moving the target document to a location corresponding to the second node.

8. The method according to claim 7, wherein the operation option comprises:
a moving option, configured to identify a third node and move the target node to the third node, thereby moving the target document to a location corresponding to the third node;
a creating shortcut option, configured to identify a fourth node and create a shortcut node for the target node at the fourth node;
a creating copy option, configured to identify a fifth node and creating a node corresponding to a copy of the target document at the fifth node, thereby creating the copy of the target document at a location corresponding to the fifth node;
a transferring ownership option, configured to transfer ownership of the target document to a specified user;
a deleting option, configured to delete the target node, thereby deleting the target document.

9. The method according to claim 7, satisfying at least one of the following:
in a case where no node is selected, the operation option being not allowed to be selected;
the location corresponding to the second node to which the target document is moved being different from a location of the target document and a location of a subordinate of the target document before the target document being moved.

10. The method according to claim 8, wherein the target operation option is the moving option and the method satisfies at least one of the following:
in a case where a document that a current user does not have moving permission is in the target document, the moving option being not allowed to be selected;
in a case where the current user does not have second preset permission for the location corresponding to the third node, the target document being not allowed to be moved to the location corresponding to the third node;
a node of another document repository that does not adopt the directory tree being not allowed to be identified as the third node;
the location corresponding to the third node to which the target document is moved being different from a location of the target document and a location of a subordinate of the target document before the target document being moved;
in a process of moving the target document, another document in the document repository being in an immovable state;
in a case where a document that the current user does not have third preset permission is in the target document, the document that the current user does not have the third preset permission being not allowed to be moved.

11. The method according to claim 8, wherein the target operation option is the deleting option and the method satisfies at least one of the following:
in a case where a document that a current user does not have deleting permission is in the target document, the deleting option being not allowed to be selected;
in a process of deleting the target document, the target document being in an operational state;
in the process of deleting the target document, in a case where the target document is moved to another location in the document repository, the target document being still deleted;
in the process of deleting the target document, in a case where the target document is moved to another document repository, deleting the target document moved to the another document repository failing;
in a case where a node that the current user does not have fourth preset permission is in the target node, the node that the current user does not have the fourth preset permission being not allowed to be deleted.

12. The method according to claim 8, wherein the target operation option is the creating shortcut option and the method satisfies at least one of the following:
in a case where a current user does not have fifth preset permission for the fourth node, the current user being not allowed to create the shortcut node of the target node at the fourth node;
a node of another document repository that does not adopt the directory tree being not allowed to be identified as the fourth node;
the fourth node where the shortcut node is created being different from the target node and a child node of the target node;
in a process of creating the shortcut node of the target document, the target document being in an operational state;
in a case where the target document is deleted in the process of creating the shortcut node of the target document, creating the shortcut node of the deleted target document failing;
in a case where the target node comprises an existing shortcut node, copying the existing shortcut node in the target node to the fourth node;
in the case where the target node comprises the existing shortcut node, the current user does not need to have permission to view a document to which the existing shortcut node corresponds.

13. The method according to claim 8, wherein the target operation option is the creating copy option and the method satisfies at least one of the following:
in a case where a document that a current user does not have permission to create a copy is in the target document, the creating copy option being not allowed to be selected;
in a case where the current user does not have sixth preset permission to the location corresponding to the fifth node, the copy of the target document at the location corresponding to the fifth node being not allowed to be created;
a node of another document repository that does not adopt the directory tree being not allowed to be identified as the fifth node;
a location corresponding to the fifth node where a created document copy is located being not belonged to a subordinate of the target document;
before creating the copy of the target document, calculating estimated time, in a case where the estimated time is less than preset time, the copy of the target document being allowed to be created, in a case where the estimated time is not less than the preset time, displaying reminder information, and after the reminder information is confirmed, creating the copy of the target document.

14. The method according to claim 8, further comprising at least one of the following:
in a case where the bulk operation corresponding to the second operation event on the target document is successful, sending a first prompt message;
in a case where the bulk operation on a part of documents of the target document is successful, sending a second prompt message, and sending a result notification message to a current user and/or an owner of the target document through a preset communication client;
in a case where the bulk operation on the target document fails, sending a third prompt message.

15. The method according to claim 14, wherein
in a case where a number of documents of failed bulk operation is not greater than a preset document number, the documents of failed bulk operation are displayed in the result notification message; and/or
in a case where the number of documents of failed bulk operation is greater than the preset document number, the preset document number of the documents of failed bulk operation and detail controls are displayed in the result notification message, each of the detail controls is configured to export detail message about a result of the bulk operation.

16. The method according to claim 15, further comprising:
in response to a triggering of each of the detail controls, creating a result document, and displaying information of the target document and a result of the bulk operation.

17. An information processing device, comprising:
a displaying unit, configured to display a directory tree corresponding to documents in a document repository, wherein nodes are displayed in the directory tree according to a hierarchical relationship of the documents, and each of the nodes corresponds to at least one document;
a controlling unit, configured to select a target node in response to a first operation event on the nodes in the directory tree; and perform a bulk operation corresponding to the second operation event on a target document corresponding to the target node in response to a second operation event on the target node;
wherein the target document comprises at least two documents, and the target node comprises at least two nodes corresponding to the at least two documents.

18. An electronic apparatus, comprising:
at least one memory and at least one processor;
wherein the at least one memory is configured to store program codes, and the at least one processor is configured to invoke the program codes stored in the at least one memory to perform the method according to claim 1.

19. A computer-readable storage medium, the computer-readable storage medium being configured for storing program codes which, when executed by a processor, cause the processor to perform the method according to claim 1.
